(19) United States
(12) Patent Application Publication
(10) Pub. No.: US 2005/0116863 A1
(43) Pub. Date: Jun. 2, 2005

(54) CIRCULARLY POLARIZED WAVE ANTENNA DEVICE SUITABLE FOR MINIATURIZATION

(75) Inventor: Dou Yuanzhu, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/994,955

(22) Filed: Nov. 22, 2004

(30) Foreign Application Priority Data
Nov. 27, 2003 (JP) 2003-397295

(51) Int. Cl. H01Q 1/38

(52) U.S. Cl. 343/700 MS; 343/846

(57) ABSTRACT

A circularly polarized wave antenna device contains a dielectric substrate provided on a ground conductor 1, a electrodes provided on the dielectric substrate to face the ground conductor. The electrodes form capacitors together with the ground conductor. A radiating conductor plate is made of a metal plate. Leg pieces are bent toward the dielectric substrate side at a plurality of locations on the radiating conductor plate. Two electric lengths on the radiating conductor plate that are generated in the directions passing the center of the radiating conductor plate and orthogonal to each other are equal to each other. Areas of the electrodes to which two leg pieces provided on a first line S3 are connected are different from those of the electrodes to which two leg pieces provided on a second line S4 are connected.

### BACKGROUND OF THE INVENTION

1. Field of the Invention

The present invention relates to a patch type of circularly polarized wave antenna device that is suitable for a GPS antenna or the like.

2. Description of the Related Art

FIG. 25 is a perspective view of a conventional circularly polarized wave antenna device. A configuration of the conventional circularly polarized wave antenna device will be described with reference to FIG. 25. A patterned ground conductor 52 is provided on a bottom surface of a thick dielectric substrate 51 made of an insulating material, and a patterned radiating conductor 53 is provided on a top surface of the dielectric substrate 51.

Further, the radiating conductor 53 is formed substantially in a square shape and has a feeding portion 54 protruding from one side thereof. In addition, circularly polarized cut portions 53a are respectively provided in two corner portions opposite to each other. In this manner, the conventional circularly polarized wave antenna device is formed (for example, see Japanese Unexamined Patent Application Publication No. 2002-237714).

However, in the conventional circularly polarized wave antenna device, the antenna efficiency is lowered due to the dielectric loss caused by the dielectric substrate 51. In addition, since the radiating conductor 53 has a rectangular shape, the overall size of the antenna device increases. As a result, it is difficult to realize a small-size antenna device.

### SUMMARY OF THE INVENTION

Accordingly, the present invention has been made to solve the above-mentioned problems, and it is an object of the present invention to provide a circularly polarized wave antenna device having a small-sized radiating conductor plate, a low dielectric loss, and excellent performance.

In order to achieve the above-mentioned object, according to a first aspect of the present invention, there is provided a circularly polarized wave antenna device comprising: a dielectric substrate provided on a ground conductor; a plurality of electrodes provided on the dielectric substrate to face the ground conductor, the plurality of electrodes forming capacitors together with the ground conductor; a radiating conductor plate made of a metal plate and arranged above the dielectric substrate at a predetermined gap; and a plurality of leg pieces bent toward the dielectric substrate side at a plurality of locations on the radiating conductor plate. In the antenna device, two electrical lengths on the radiating conductor plate that are generated in the directions passing the center of the radiating conductor plate and being orthogonal to each other are equal to each other, and the leg pieces are four in which two leg pieces are provided on each of first and second lines that pass the center of the radiating conduct plate and are orthogonal to each other at locations except a central portion of the radiating conductor plate. In addition, the leg pieces are connected to the electrodes, respectively, and areas of the electrodes to which the two leg pieces provided on the first line are connected are different from those of the electrodes to which the two leg pieces provided on the second line are connected.

Further, according to a second aspect of the present invention, the ground conductor is formed of a ground conductor plate made of a metal plate larger than the radiating conductor plate.

Furthermore, according to a third aspect of the present invention, the four leg pieces are provided at locations separated from the center of the radiating conductor plate by the same distance.

Further, according to a forth aspect of the present invention, the radiating conductor plate is formed in an octagonal shape and has a pair of first opposing sides and a pair of second opposing sides respectively located on the first and second lines, and the leg pieces are provided at locations between the first and second opposing sides on the first and second lines, except the central portion of the radiating conductor plate.

Furthermore, according to a fifth aspect of the present invention, the leg pieces are provided along the first and second opposing sides.

Further, according to a sixth aspect of the present invention, the leg pieces are provided at locations closer to the central portion of the radiating conductor plate than to the first and second opposing sides.

As described above, a circularly polarized wave antenna device of the present invention comprises a dielectric substrate provided on a ground conductor; a plurality of electrodes provided on the dielectric substrate to face the ground conductor, the plurality of electrodes forming capacitors together with the ground conductor; a radiating conductor plate made of a metal plate and arranged above the dielectric substrate at a predetermined gap; and a plurality of leg pieces bent toward the dielectric substrate side at a plurality of locations on the radiating conductor plate. In the antenna device, two electrical lengths on the radiating conductor plate that are generated in the directions passing the center of the radiating conductor plate and being orthogonal to each other are equal to each other, and the leg pieces are four in which two leg pieces are provided on each of first and second lines that pass the center of the radiating conduct plate and are orthogonal to each other at locations except a central portion of the radiating conductor plate. In addition, the leg pieces are connected to the electrodes, respectively, and areas of the electrodes to which the two leg pieces provided on the first line are connected are different from those of the electrodes to which the two leg pieces provided on the second line are connected. in this manner, since the capacitors are formed by the electrodes and the ground conductor, a resonance frequency decreases. Therefore, it is possible to achieve a radiating conductor plate having a small size.

In addition, the difference between two electrical lengths occurs by changing the areas of the electrodes, so that a circularly polarized wave is obtained. Therefore, it is possible to achieve a circularly polarized wave antenna device with a simple structure and high productivity.

In addition, since the dielectric substrate may be composed of a thin plate similar to the circuit board, it is possible to greatly suppress the influence of the dielectric loss, thereby achieving a circularly polarized antenna having excellent performance. In addition, the installation of the radiating conductor plate and the connection of the radiating conductor plate to the electrodes can be carried out only by soldering the leg pieces to the electrodes. Therefore, it is possible to achieve a circularly polarized wave antenna device having a low manufacturing cost and high productivity.

Furthermore, since the ground conductor is formed of a ground conductor plate made of a metal plate larger than the radiating conductor plate, the ground conductor plate can be composed of an inexpensive metal plate, such as an iron plate. Therefore, it is possible to achieve a circularly polarized wave antenna device having a low manufacturing cost.

Further, since the tour leg pieces are provided at locations separated from the center of the radiating conductor plate by the same distance, distances from the center of the radiating conductor plate to front ends of the leg pieces are equal to each other. Therefore, electric characteristics can be stabilized.

In addition, the radiating conductor plate is formed in an octagonal shape and has a pair of first opposing sides and a pair of second opposing sides respectively located on the first and second lines, and the leg pieces are provided at locations between the central portion of the radiating conductor plate and the first and second opposing sides on the first and second lines, except the central portion of the radiating conductor plate. Therefore, the size of the radiating conductor plate can decrease, and the installation of the leg pieces can be stabilized in view of the installation locations.

Further, since the leg pieces are provided along the first and second opposing sides, a radiating conductor plate having a larger area can be obtained.

Further, since the leg pieces are provided at locations closer to the central portion of the radiating conductor plate than to the first and second opposing sides, the leg pieces composed of bent pieces can be formed by bending the outer circumference of the radiating conductor plate. Therefore, it is possible to achieve a circularly polarized wave antenna device having a low material cost and a low manufacturing cost.

### BRIEF DESCRIPTION OF THE DRAWINGS

FIG. 1 is a plan view of a circularly polarized wave antenna device according to a first embodiment of the present invention;

FIG. 2 is a plan view of the circularly polarized wave antenna device according to the first embodiment of the present invention in a state in which a cover is removed from the circularly polarized wave antenna device;

FIG. 3 is a sectional view taken along the line 3-3 of FIG. 1;

FIG. 4 is a sectional view taken along the line 4-4 of FIG. 1;

FIG. 5 is an exploded perspective view of the circularly polarized wave antenna device according to the first embodiment of the present invention;

FIG. 6 is a plan view of a ground conductor plate of the circularly polarized wave antenna device according to the first embodiment of the present invention;

FIG. 7 is a perspective view of the ground conductor plate of the circularly polarized wave antenna device according to the first embodiment of the present invention;

FIG. 8 is a plan view of a circuit board of the circularly polarized wave antenna device according to the first embodiment of the present invention;

FIG. 9 is a plan view of a radiating conductor plate of the circularly polarized wave antenna device according to the first embodiment of the present invention;

FIG. 10 is a front view of the radiating conductor plate of the circularly polarized wave antenna device according to the first embodiment of the present invention;

FIG. 11 is a bottom view of the radiating conductor plate of the circularly polarized wave antenna device according to the first embodiment of the present invention;

FIG. 12 is a plan view of the cover of the circularly polarized wave antenna device according to the first embodiment of the present invention;

FIG. 13 is a left side view of the cover of the circularly polarized wave antenna device according to the first embodiment of the present invention;

FIG. 14 is a sectional view of essential elements of the cover of the circularly polarized wave antenna device according to the first embodiment of the present invention;

FIG. 15 is a bottom view of the cover of the circularly polarized wave antenna device according to the first embodiment of the present invention;

FIG. 16 is an explanatory view showing a first step of a method of mounting the radiating conductor plate on the circuit board in the circularly polarized wave antenna device according to the first embodiment of the present invention;

FIG. 17 is an explanatory view showing a second step of the method of mounting the radiating conductor plate on the circuit board in the circularly polarized wave antenna device according to the first embodiment of the present invention;

FIG. 18 is an explanatory view showing a third step of the method of mounting the radiating conductor plate on the circuit board in the circularly polarized wave antenna device according to the first embodiment of the present invention;

FIG. 19 is an explanatory view showing a state in which the steps of the method of mounting the radiating conductor plate on the circuit board is completed in the circularly polarized wave antenna device according to the first embodiment of the present invention;

FIG. 20 is an explanatory view showing a method of mounting a cable on the ground conductor plate in the circularly polarized wave antenna device according to the first embodiment of the present invention;

FIG. 21 is a perspective view showing a state in which a step of mounting the cable on the ground conductor plate is completed in the circularly polarized wave antenna device according to the first embodiment of the present invention;

FIG. 22 is a plan view of a circularly polarized wave antenna device according to a second embodiment of the present invention in a state in which a cover is removed from the circularly polarized wave antenna device;

FIG. 23 is a plan view of a circuit board of the circularly polarized wave antenna device according to the second embodiment of the present invention;

FIG. 24 is a plan view of a radiating conductor plate of a circularly polarized wave antenna device according to a third embodiment of the present invention; and

FIG. 25 is a perspective view of a conventional circularly polarized wave antenna device.

### DESCRIPTION OF THE PREFERRED EMBODIMENTS

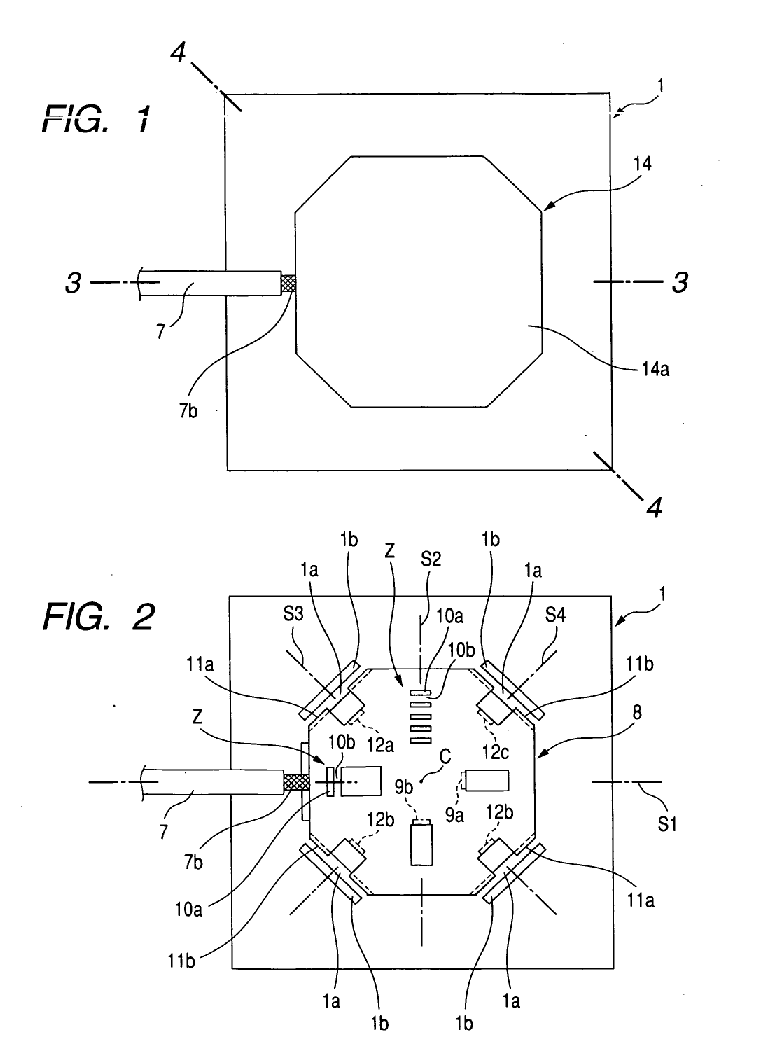

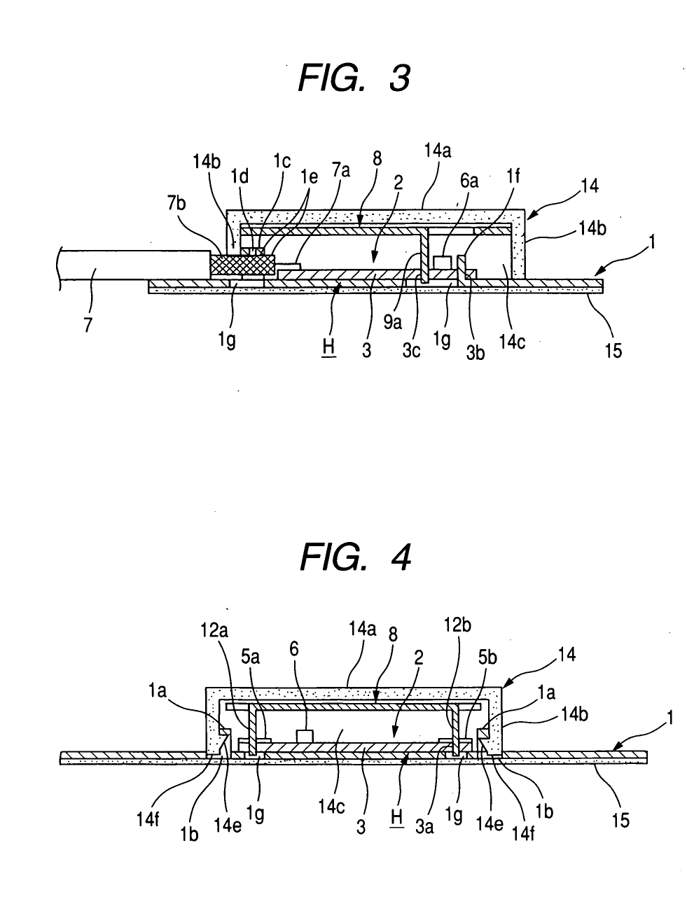

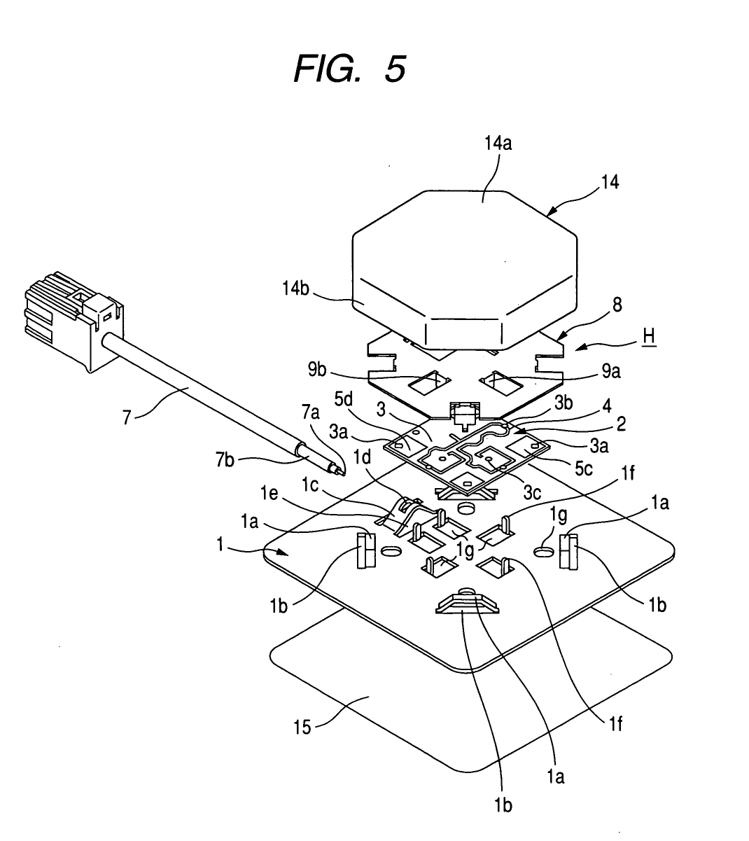

A circularly polarized wave antenna device of the present invention will now be described with reference to the accompanying drawings. FIG. 1 is a plan view of a circularly polarized wave antenna device according to a first embodiment of the present invention; FIG. 2 is a plan view of the circularly polarized wave antenna device according to the first embodiment of the present invention in a state in which a cover is removed from the circularly polarized wave antenna device; FIG. 3 is a sectional view taken along the line 3-3 of FIG. 1; FIG. 4 is a sectional view taken along the line 4-4 of FIG. 1; and FIG. 5 is an exploded perspective view of the circularly polarized wave antenna device according to the first embodiment of the present invention.

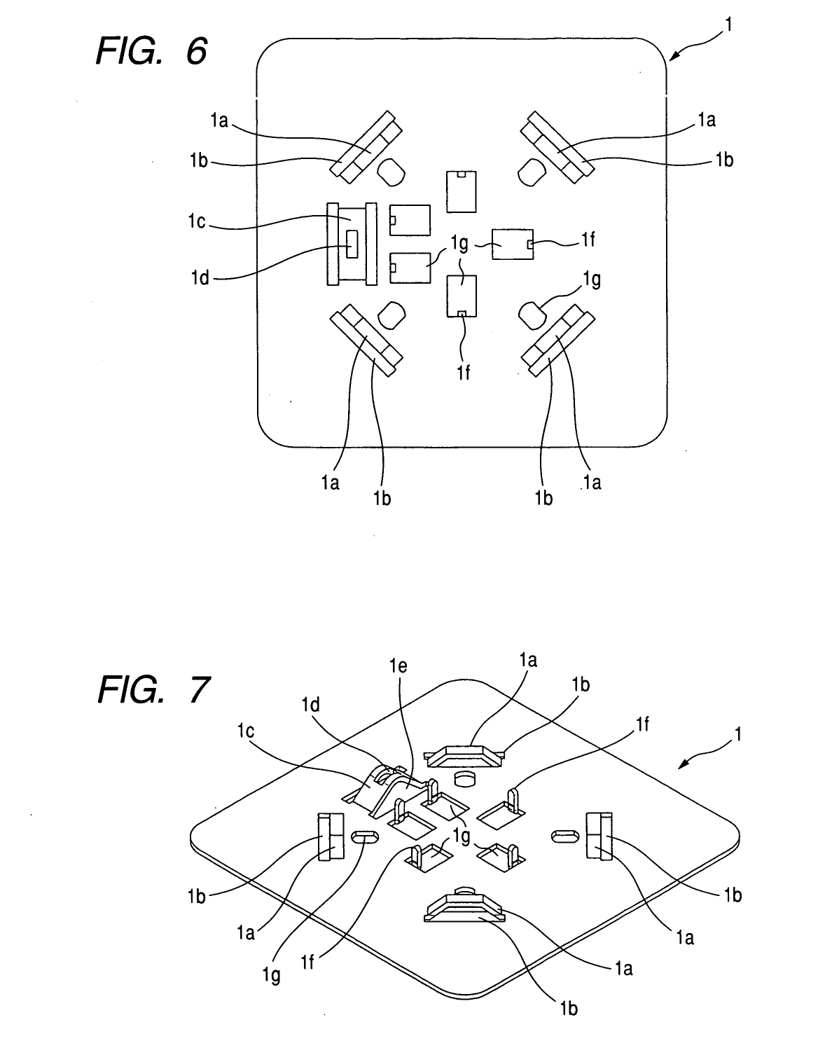

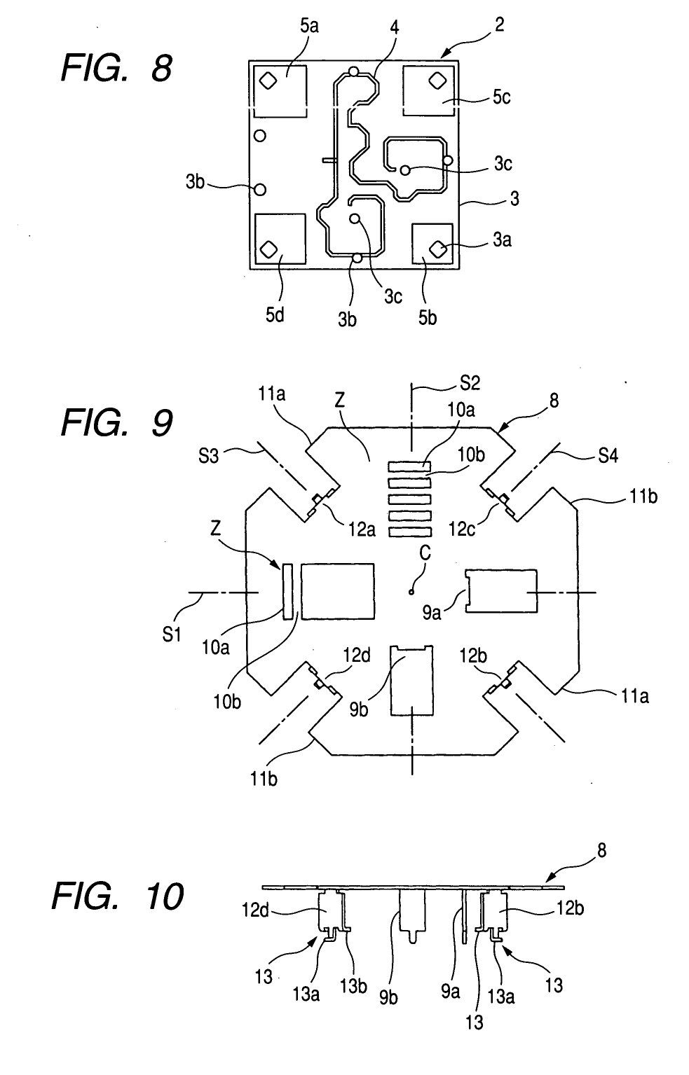

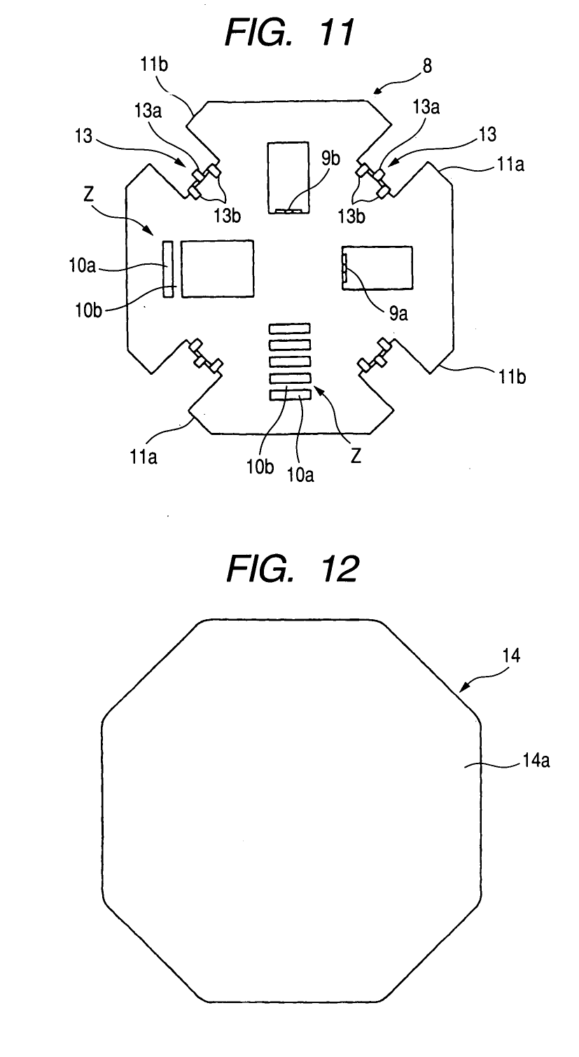

Further, FIG. 6 is a plan view of a ground conductor plate of the circularly polarized wave antenna device according to the first embodiment of the present invention; FIG. 7 is a perspective view of the ground conductor plate of the circularly polarized wave antenna device according to the first embodiment of the present invention; FIG. 8 is a plan view of a circuit board of the circularly polarized wave antenna device according to the first embodiment of the present invention; FIG. 9 is a plan view of a radiating conductor plate of the circularly polarized wave antenna device according to the first embodiment of the present invention; FIG. 10 is a front view of the radiating conductor plate of the circularly polarized wave antenna device according to the first embodiment of the present invention; and FIG. 11 is a bottom view of the radiating conductor plate of the circularly polarized wave antenna device according to the first embodiment of the present invention.

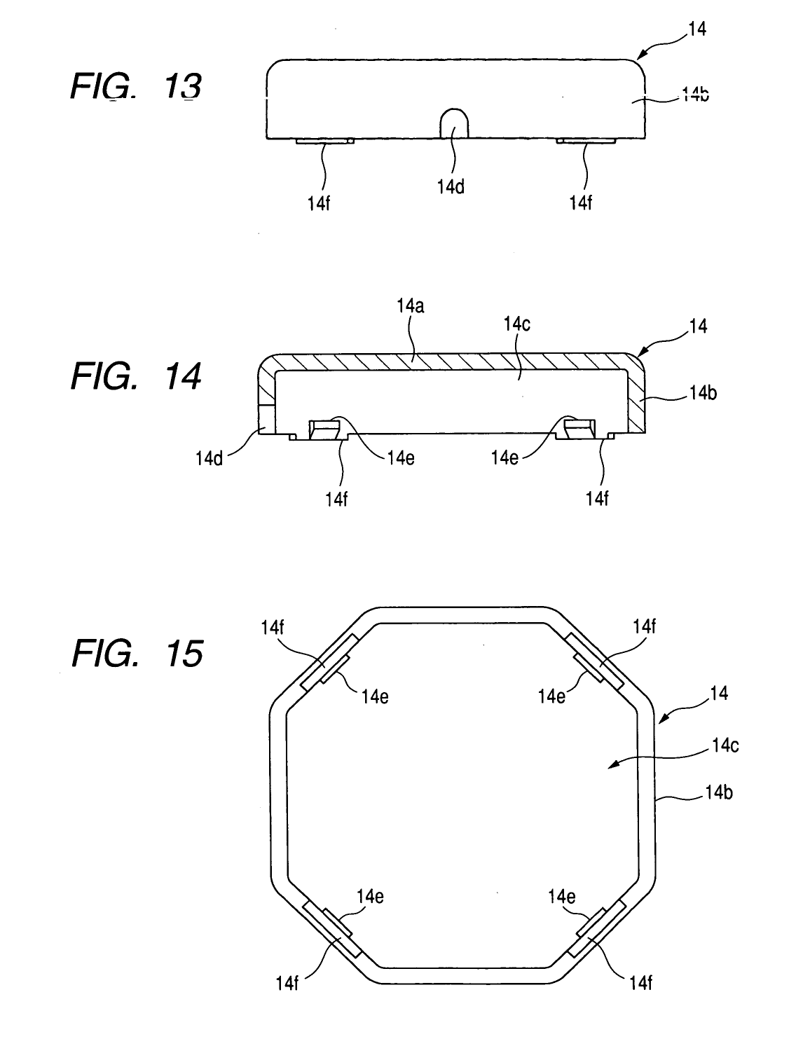

Further, FIG. 12 is a plan view of the cover of the circularly polarized wave antenna device according to the first embodiment of the present invention; FIG. 13 is a left side view of the cover of the circularly polarized wave antenna device according to the first embodiment of the present invention; FIG. 14 is a sectional view of essential elements of the cover of the circularly polarized wave antenna device according to the first embodiment of the present invention; and FIG. 15 is a bottom view of the cover of the circularly polarized wave antenna device according to the first embodiment of the present invention.

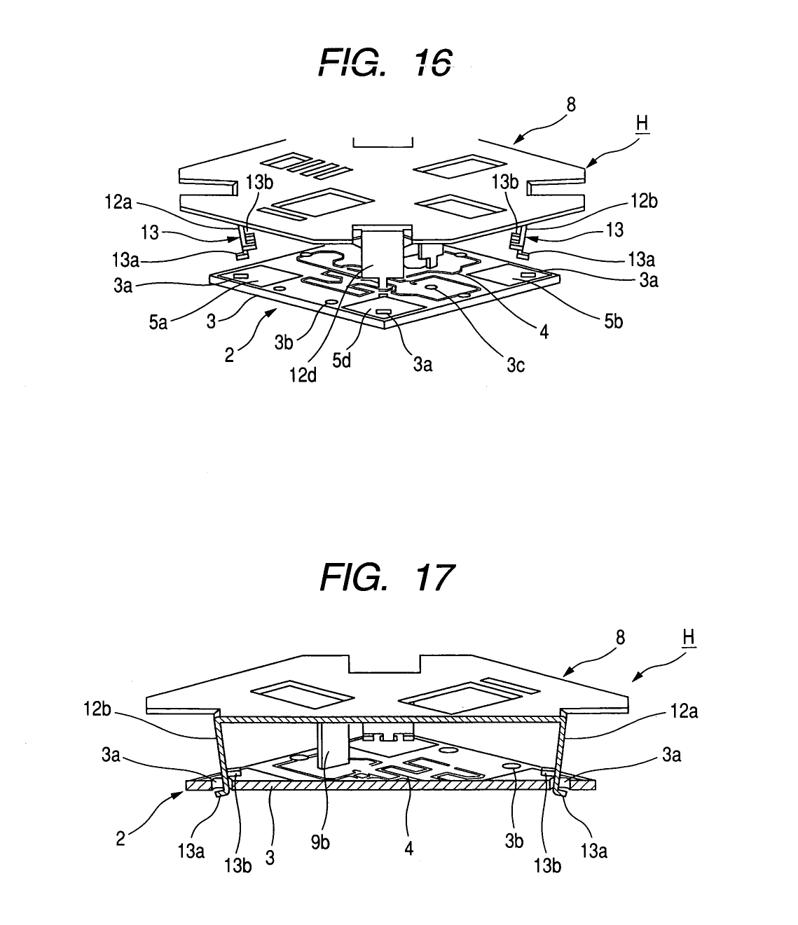

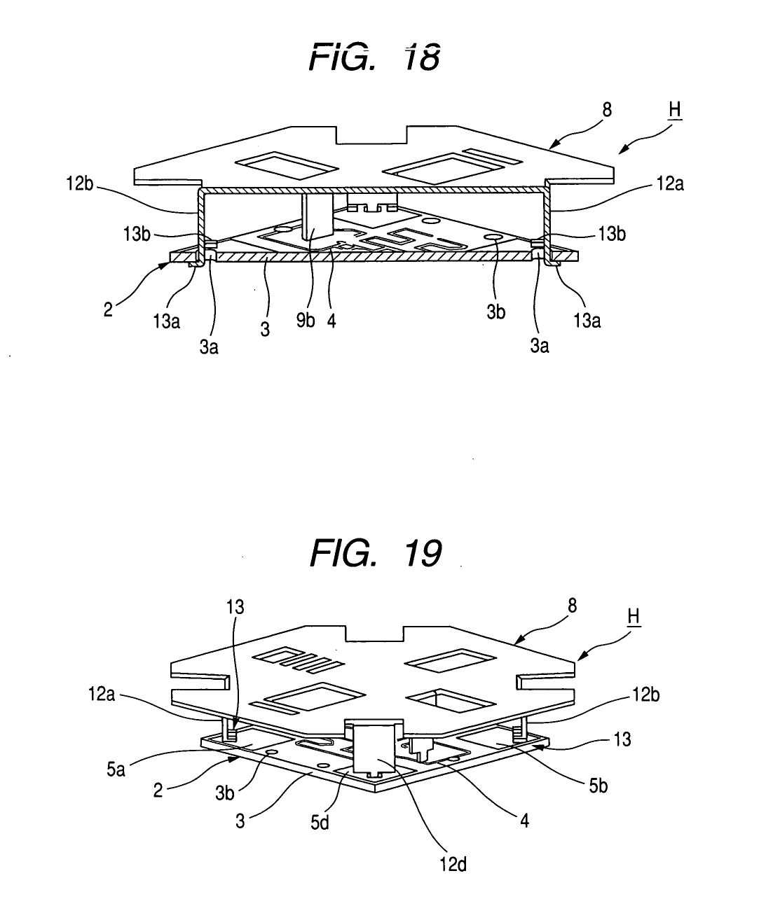

Furthermore, FIG. 16 is an explanatory view showing a first step of a method of mounting the radiating conductor plate on the circuit board in the circularly polarized wave antenna device according to the first embodiment of the present invention; FIG. 17 is an explanatory view showing a second step of the method of mounting the radiating conductor plate on the circuit board in the circularly polarized wave antenna device according to the first embodiment of the present invention; FIG. 18 is an explanatory view showing a third step of the method of mounting the radiating conductor plate on the circuit board in the circularly polarized wave antenna device according to the first embodiment of the present invention; and FIG. 19 is a perspective view showing a state in which the steps of mounting the radiating conductor plate on the circuit board are completed in the circularly polarized wave antenna device according to the first embodiment of the present invention.

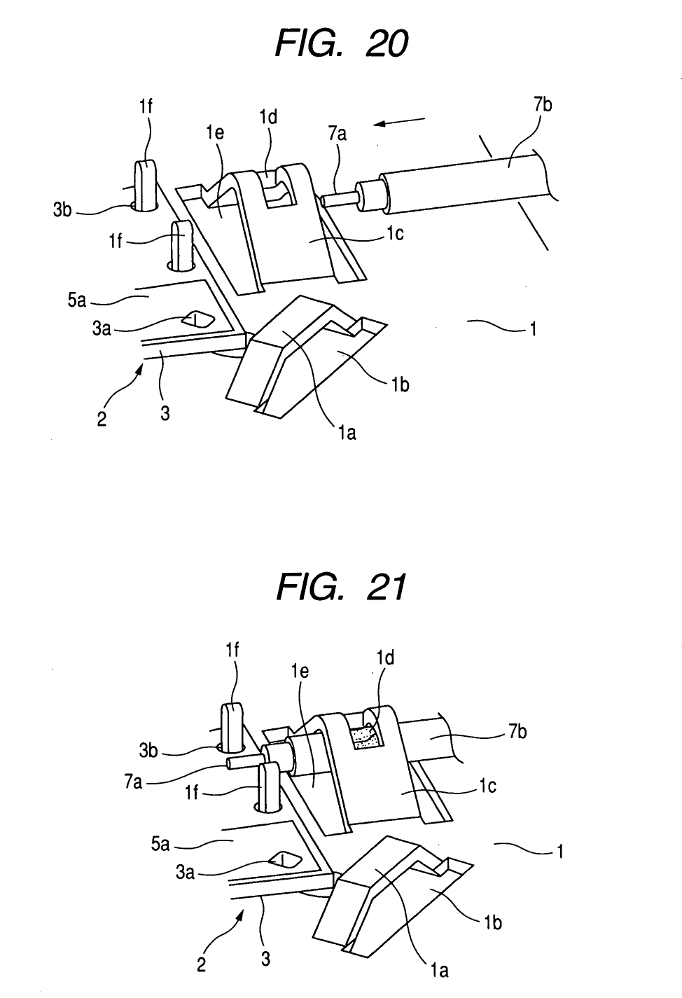

Furthermore, FIG. 20 is an explanatory view showing a method of mounting a cable on the ground conductor plate in the circularly polarized wave antenna device according to the first embodiment of the present invention; and FIG. 21 is a perspective view showing a state in which mounting the cable on the ground conductor plate is completed in the circularly polarized wave antenna device according to the first embodiment of the present invention.

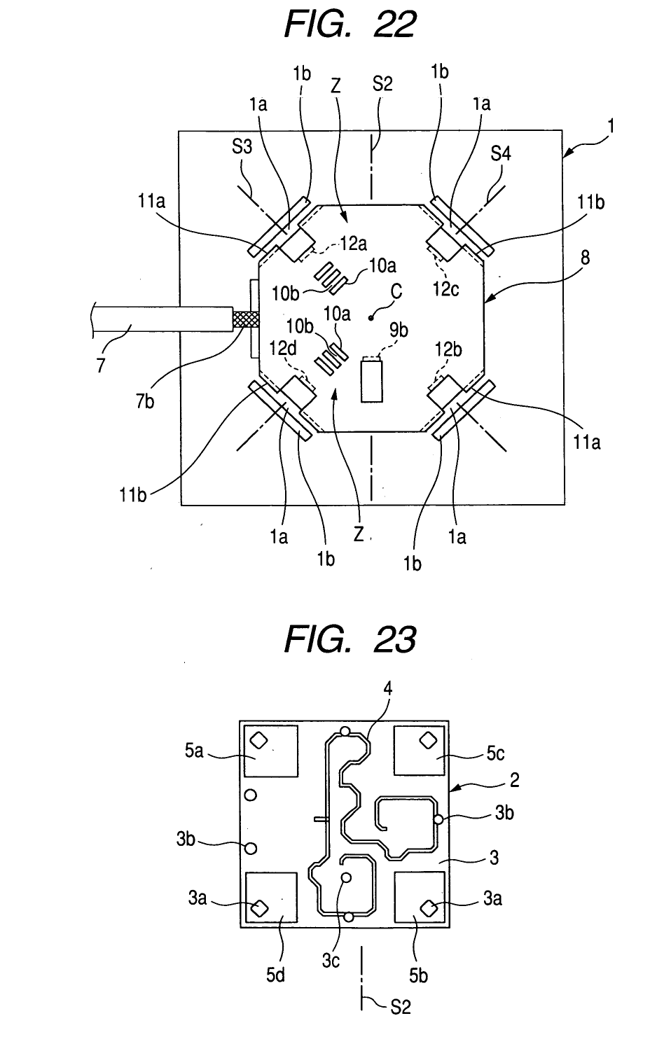

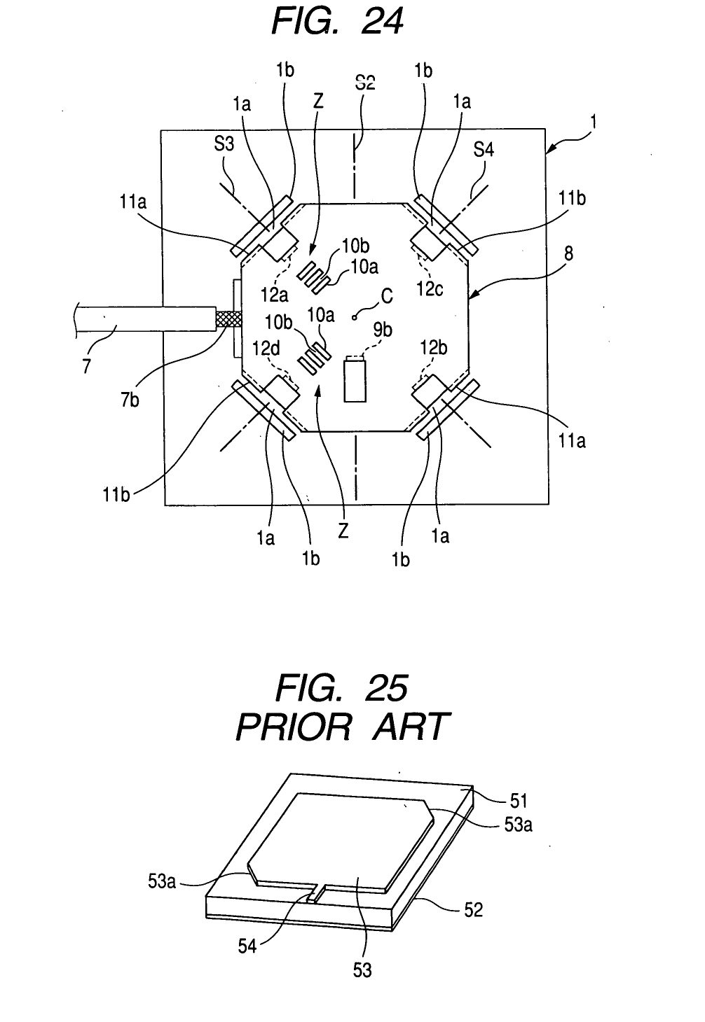

Furthermore, FIG. 22 is a plan view of a circularly polarized wave antenna device according to a second embodiment of the present invention in a state in which a cover is removed from the circularly polarized wave antenna device; FIG. 23 is a plan view of a circuit board of the circularly polarized wave antenna device according to the second embodiment of the present invention; and FIG. 24 is a plan view of a radiating conductor plate of a circularly polarized wave antenna device according to a third embodiment of the present invention.

Next, the configuration of the circularly polarized wave antenna device according to the first embodiment of the present invention will be described with reference to FIGS. 1 to 21. A ground conductor plate 1, serving as a ground conductor, is composed of a metal plate. The ground conductor plate 1 comprises a plurality of hooking portions 1a that is cut and erected upward in an arch shape and holes 1b provided in the vicinities of the hooking portions 1a, which are provided at locations in all directions, and a plurality of stopper portions 1c that is cut and erected upward in an arch shape, cut-out portions id each composed of a through hole provided in the vicinity of a top portion of the stopper portion 1c, and inserting portions 1e each provided in a bottom portion of the stopping portion 1c, which are provided between two hooking portions 1a, as shown particularly in FIGS. 6 and 7.

In addition, the ground conductor plate 1 has a plurality of bent pieces if bent toward the upper side of the ground conductor plate 1 and release holes 1 g formed at a plurality of positions including the vicinities of the bent pieces 1f.

As shown particularly in FIG. 8, a circuit board 2 having a rectangular shape comprises a dielectric substrate 3 composed of an insulating plate, a wiring pattern 4 provided on the dielectric substrate 3, and a plurality of first, second, third, and fourth electrodes 5a, 5b, 5c, and 5d provided at four corner portions of the dielectric substrate 3.

Further, the first and second electrodes 5a and 5b that are obliquely opposite to each other have the same area, and the third and fourth electrodes 5c and 5d that are obliquely opposite to each other have the same area. However, the areas of the first and second electrodes 5a and 5b are smaller than those of the third and fourth electrodes 5c and 5d.

Furthermore, the dielectric substrate 3 comprises a plurality of penetrating portions 3a composed of through holes formed at the locations of the first to fourth electrodes 5a to 5d, a plurality of first holes 3b formed near the outer circumference of the dielectric substrate 3, and a plurality of second holes 3c formed at a central portion of the dielectric substrate 3.

In addition, on the circuit board 2, electronic components 6 including a short chip type of capacitor, a tall dielectric filter 6a, and the like are mounted, and a desired electric circuit composed of a matching circuit, a filter circuit, and an amplifying circuit is provided.

In addition, the tall electronic component 6 composed of the dielectric filter 6a or the like is arranged near the outer circumference of the circuit board 2.

In the circuit board 2 having the above-mentioned structure, in a state in which the bent pieces 1f are inserted into the first holes 3b, the bottom surface of the circuit board 2 is mounted on the ground conductor plate 1, the bent pieces if are soldered to the wiring pattern 4, and the circuit board 2 is supported by the bent pieces 1f, as shown particularly in FIGS. 3 and 5.

At this time, the bent pieces if pass through the first holes 3b so that front ends of the bent pieces 1f protrude upward, and the release holes 1g of the ground conductor plate 1 are located under the penetrating portions 3a and the second holes 3c of the circuit board 2. Therefore, the penetrating portion 3a and the second holes 3c escape from the ground conductor plate 1.

In addition, when the circuit board 2 is mounted on the ground conductor plate 1, the first to fourth electrodes 5a to 5d face the ground conductor plate 1 with the dielectric substrate 3 interposed therebetween to form capacitors, respectively.

A coaxial cable 7 comprises a central conductor 7a and a reticulated outer conductor 7b covering the outside of the central conductor 7a with an insulated covering portion interposed therebetween. When the cable 7 is installed, first, a front end of the cable 7 is inserted into the inserting portion 1e of the stopper portion 1c, as shown in FIG. 20. A state in which the installation of the cable 7 is completed is shown in FIG. 21.

In addition, in the state shown in FIG. 21, the central conductor 7a is soldered to the wiring pattern 4, the outer conductor 7b and the stopper portion 1c are soldered at the location of the cut-out portion 1d, and the cable 7 is supported by the stopper portion 1c.

An octagonal radiating conductor plate 8 is composed of a metal plate. The radiating conductor plate 8 comprises first and second feeding portions 9a and 9b composed of bent pieces bent toward the lower side of the radiating conductor plate 8, which are respectively provided at locations orthogonal to each other, and adjusting means Z for adjusting electrical lengths respectively provided on a line S1 passing the first feeding portion 9a and a center C and on a line S2 passing the second feeding portion 9b and the center C, as shown particularly in FIGS. 9 to 11.

Further, the direction of the electric field on the radiating conductor plate 8 is the same as the directions of the lines S1 and S2, and first and second electrical lengths are generated respectively in the directions of the lines S1 and S2.

Furthermore, the adjusting means Z are provided along the lines S1 and S2, which are the electric field directions, and are provided at locations between the central portion and the outer circumference, except for the location of the central portion of the radiating conductor plate 8.

In addition, the adjusting means Z are provided at sides opposite to the first and second feeding portions 9a and 9b centering the center C and are composed of ladder portions formed by combining holes 10a with crosspiece portions 10b. In the adjusting means, by cutting the crosspieces 10b, the electrical length can be adjusted so as to extend.

In addition, the radiating conductor plate 8 comprises a pair of first opposing sides 11a located on the line S3 and a pair of second opposing sides 11b located on the line S4. The lines S3 and S4 pass the center C and are orthogonal to each other, and four leg pieces 12a, 12b, 12c, and 12d are provided at the locations between the central portion of the radiating conductor plate 8 and the first and second opposing sides 11a and 11b on the lines S3 and S4, except the central portion.

The four leg pieces 12a to 12d are bent downward at locations separated from the center C by the same distance and are provided at locations closer to the center C than to the first and second opposing sides 11a and 11b.

In addition, the electric field intensity of the radiating conductor plate 8 is strong at the outer circumferential portions of the radiating conductor plate 8 on the lines S1 and S2. However, the leg pieces 12a to 12d are provided at the locations where the electric field intensity is weak with the leg pieces 12a to 12d apart from the lines S1 and S2.

Further, locking portions 13 are provided at end portions of the leg pieces 12a to 12d, respectively, and each locking portion 13 comprises a first locking piece 13a located at the lowest location and a second locking piece 13b provided apart from the first locking piece 13a.

In addition, the first and second locking pieces 13a and 13b are bent in the directions opposite to each other, centering each of the leg pieces 12a to 12d.

When the radiating conductor plate 8 having the above-mentioned structure is installed, first, the leg pieces 12a to 12d are bent inward against the elasticity of the leg pieces 12a to 12d in a state in which the radiating conductor plate 8 is arranged on the circuit board 2, as shown in FIG. 16.

Next, as shown in FIG. 17, convex portions of the front ends of the first and second feeding portions 9a and 9b are fitted into the second holes 3c, and the locking portions 13 of the leg pieces 12a to 12d are inserted into the penetrating portions 3a.

After that, as shown in FIG. 18, when releasing the inward bending force of the leg pieces 12a to 12d, the leg pieces 12a to 12d return to the original state by the elasticity of the leg pieces 12a to 12d themselves, the first locking pieces 13a are locked onto the back surface of the circuit board 2, and the second locking pieces 13b are locked onto the top surface of the circuit board 2. As a result, the radiating conductor plate 8 is temporally fastened on the circuit board 2, as shown in FIG. 19.

In addition, the leg pieces 12a to 12d are respectively connected to the first to fourth electrodes 5a to 5d by soldering, and the first and second feeding portions 9a and 9b are soldered to the wiring. pattern 4 provided at the periphery of the third holes 3c. By using the circuit board 2 and the radiating conductor plate 8, an antenna main body portion H is formed.

At that time, the leg pieces 12a to 12d and the first and second feeding portions 9a and 9b are not electrically connected to the ground conductor plate 1 by the release holes 1g.

In this manner, the radiating conductor plate 8 mounted on the circuit board 2 is arranged parallel to the ground conductor plate 1 and the circuit board 2 at a predetermined gap therefrom, and the first electrical length of the radiating conductor plate 8 is determined by the length of the radiating conductor plate 8 on the line S1 and the magnitude of the capacitance formed by the electrodes 5a and 5b. In addition, the second electrical length of the radiating conductor plate 8 is determined by the length of the radiating conductor plate 8 on the line S2 and the magnitude of the capacitance formed by the electrodes 5c and 5d.

According to the first embodiment, the length of the radiating conductor plate 8 on the line S1 is the same as the length of the radiating conductor plate 8 on the line S2. However, since the capacitance of the capacitor formed by the first and second electrodes 5a and 5b is smaller than that of the capacitor formed by the third and fourth electrodes 5c and 5d, the first electrical length is shorter than the second electrical length, so that the difference between the first electrical length and the second electrical length occurs, thereby obtaining a circularly polarized wave antenna device.

In addition, when the radiating conductor plate 8 is installed, the ground conductor plate 1 having an area larger than that of the radiating conductor plate 8 exists under the entire lower portion of the radiating conductor plate 8, and the circuit board 2 is located within the plane area of the radiating conductor plate 8 between the radiating conductor plate 8 and the ground conductor plate 1.

In addition, when the radiating conductor plate 8 is installed, the top surfaces of the hooking portion 1a, the stopper portion 1c, and the tall electronic component 6a are arranged to be opposite to the vicinity of the circumferential portion of the radiating conductor plate 8, and the front ends of the bent portions 1f are arranged opposite to the radiating conductor plate 8. As a result, capacitance is generated between the radiating conductor plate 8 and the hooking portion 1a, the stopper portion 1c, the tall electronic component 6a, and the bent portion 1f.

Further, the radiating conductor plate 8 is installed, the hooking portion 1a and the stopper portion 1c are arranged along the outer circumference of the radiating conductor plate 8 so that the hooking portion 1a and the stopper 1c are formed to lean toward the center C of the radiating conductor plate 8, thereby achieving a circularly polarized wave antenna device having a small size.

In addition, the lengths of the radiating conductor plate 8 on the lines S1 and S2, the capacitances of the first to fourth electrodes 5a to 5d, and the capacitances between the radiating conductor plate 8 and the hooking portion 1a, the stopper portion 1c, the tall electronic component 6a, and the bent portion if are set so that the frequency decreases, thereby achieving a circularly polarized wave antenna device having a small size.

A cup-shaped cover 14 made by molding an insulating material comprises an octagonal upper wall 14a, eight side walls 14b extending downward from eight sides of the upper wall 14a, a receiving portion 14c surrounded by the upper wall 14a and the side walls 14b, a concave portion 14d provided in the lower portion of one side wall 14b, clasp-shaped locking portions 14e respectively provided at the inner surface side of the lower portion of the side wall 14b every other side wall, and convex portions 14f protruding downward from the lower portion of each side wall 14b at which each locking portion 14e is located, as shown particularly in FIGS. 12 to 15.

In the cover 14, the entire antenna main body portion H composed of the radiating conductor portion 8 and the circuit board 2 is accommodated in the receiving portion 14c. In addition, in a state in which the locking portions 14e are put on the hooking portions 1a, when being pressed downward (on the side of the ground conductor plate 1), the locking portions 14e are snapped to the lower portions of the hooking portions 1a to be locked into them, so that the cover 14 is attached to the ground conductor plate 1.

At this time, the convex portions 14f provided at the lower portions of the side walls 14b are fitted into the holes 1b near the hooking portions 1a, and the cable 7 is located in the concave portion 14d, so that the cable 7 is pressed in the concave portion 14d.

A sealing sheet 15 is made of a label whose one surface is provided with an adhesive and is bonded to a back surface of the ground conductor plate 1. Therefore, the sealing sheet 15 covers the release holes 1g.

According to the above-mentioned configuration, the circularly polarized wave antenna device according to the first embodiment of the present invention can be formed.

Further, FIGS. 22 and 23 show a circularly polarized wave antenna device according to a second embodiment of the present invention. The circularly polarized wave antenna device according to the second embodiment will be now described with reference to FIGS. 22 and 23. A radiating conductor plate 8 according to the second embodiment has a feeding portion 9b composed of a bent piece which is provided on the line S2 passing the center C.

In addition, in the radiating conductor plate 8, the directions of the lines S3 and S4 passing the center C with the lines S3 and S4 displaced by 45 degrees with respect to the line S2 become the direction of electric field, and a first electrical length generated in the direction of the line S3 and a second electrical length generated in the direction of the line S4 exist.

In addition, adjusting means Z are provided along the lines S3 and S4, which are the electric field directions, and are provided at locations between the central portion and the outer circumference of the radiating conductor plate 8, except the central portion of the radiating conductor plate 8. Further, in the adjusting means Z, by cutting crosspieces 10a of the adjusting means Z related to ladder portions, the electrical length can be adjusted so as to extend.

In addition, the radiating conductor plate 8 comprises a pair of first opposing sides 11a located on the line S3 and a pair of second opposing sides 11b located on the line S4, and the lines S3 and S4 pass the center C and is orthogonal to each other. Further, four leg pieces 12a, 12b, 12c, and 12d provided at the locations between the central portion of the radiating conductor plate 8 and the first and second opposing sides 11a and 11b on the lines S3 and S4, except the central portion of the radiating conductor plate 8.

The four leg pieces 12a to 12d are bent downward at locations separated from the center C by the same distance and are provided at locations closer to the center C than to the first and second opposing sides 11a and 11b.

In addition, the electric field intensity of the radiating conductor plate 8 is strong at the outer circumferential portions of the radiating conductor plate 8 on the lines S3 and S4. Therefore, the leg pieces 12a to 12d are provided at the locations on the lines S3 and S4 where the electric field intensity is strong.

Further, first to fourth electrodes 5a to 5d to which the leg pieces 12a to 12d are connected have different areas, so that the difference between the first electric field and the second electric field occurs, thereby obtaining a circularly polarized wave antenna device.

The other structures of the second embodiment are the same as those of the first embodiment, the same constituent elements as those in the first embodiment have the same reference numerals. Thus, the description thereof will be omitted.

In addition, FIG. 24 shows a circularly polarized wave antenna device according to a third embodiment of the present invention. According to the third embodiment, leg pieces 12a to 12d are provided along first and second opposing sides 11a and 11b of a radiating conductor plate 8.

The other structures of the third embodiment are the same as those of the first embodiment, the same constituent elements as those in the first embodiment have the same reference numerals. Thus, the description thereof will be omitted.

1. A circularly polarized wave antenna device comprising:
a dielectric substrate provided on a around conductor a plurality of electrodes provided on the dielectric substrate to face the ground conductor, the plurality of electrodes forming capacitors together with the ground conductor;
a radiating conductor plate made of a metal plate and arranged above the dielectric substrate at a predetermined gap; and
a plurality of leg pieces bent toward the dielectric substrate side at a plurality of locations on the radiating conductor plate,
wherein two electrical lengths on the radiating conductor plate that are generated in directions passing a center of the radiating conductor plate and being orthogonal to each other are equal to each other,
the leg pieces contain two leg pieces provided on each of first and second lines that pass the center of the radiating conduct plate, the two leg pieces are orthogonal to each other at locations except a central portion of the radiating conductor plate,
the leg pieces are connected to the electrodes, respectively, and
areas of the electrodes to which the two leg pieces provided on the first line are connected are different from those of the electrodes to which the two leg pieces provided on the second line are connected.

2. The circularly polarized wave antenna device according to claim 1,
wherein the ground conductor is formed of a ground conductor plate made of a metal plate larger than the radiating conductor plate.

3. The circularly polarized wave antenna device according to claim 1, wherein the four leg pieces are provided at locations separated from the center of the radiating conductor plate by the same distance.

4. The circularly polarized wave antenna device according to claim 1,
wherein the radiating conductor plate is formed in an octagonal shape and has a pair of first opposing sides and a pair of second opposing sides respectively located on the first and second lines, and
the leg pieces are provided at locations between the central portion of the radiating conductor plate and the first and second opposing sides on the first and second lines, except the central portion of the radiating conductor plate.

5. The circularly polarized wave antenna device according to claim 4,
wherein the leg pieces are provided along the first and second opposing sides.

6. The circularly polarized wave antenna device according to claim 4,
wherein the leg pieces are provided at locations closer to the central portion of the radiating conductor plate than to the first and second opposing sides.
